(19) United States
(12) Patent Application Publication
(10) Pub. No.: US 2009/0232486 A1
(43) Pub. Date: Sep. 17, 2009

(54) IMAGE CAPTURING APPARATUS

(75) Inventors: Yuichi SATO, Saga (JP); Koichi MORITA, Nara (JP); Shuji YAHAGI, Fukuoka (JP)

Correspondence Address: PEARNE & GORDON LLP, 1801 EAST 9TH STREET, SUITE 1200, CLEVELAND, OH, 44114-3108, US

(73) Assignee: Panasonic Corporation, Osaka (JP)

(21) Appl. No.: 12/401,980

(22) Filed: Mar. 11, 2009

(30) Foreign Application Priority Data
Mar. 14, 2008 (JP) 2008-065374

(51) Int. Cl. G03B 15/06

(52) U.S. Cl. 396/200

(57) ABSTRACT

In the image capturing apparatus which images a micro plate 10 in which a liquid sample is contained as a screening object, an imaging unit 3 having a first optical axis A1 and an illumination unit 4 having a second optical axis A2 are housed in a positional relation therebetween to be vertically overlapped with each other, the micro plate 10 is held in a horizontal attitude at a selected observation position of any one of the first observation position [P1] and the second observation position [P2] which are set at the positions higher or lower than the first optical axis A1, respectively, and an optical path of light irradiated along the first optical axis A1 is bent to any one of an optical path 1 at an upper side or an optical path 2 at a lower side by using an optical path switching unit 7 which is disposed at a middle position [PM]. Therefore, it is possible to image the micro plate 10 from any one of the upper side and the lower side thereof.

### BACKGROUND OF THE INVENTION

1. Field of the Invention

The present invention relates to an image capturing apparatus that captures an image of an observation object by imaging a plate-like container containing the observation object such as a liquid sample.

2. Description of the Invention

In recent years, as a scale of screening is rapidly widened in a field of drug discovery screening which is performed in pharmaceutical industries, a technique of high throughput screening (HTS) has been introduced, which finds a target chemical compound by efficiently estimating a large amount of specimen samples in a short time by using an automatic system. In this high throughput screening, after a dispensing operation or incubation is performed on the specimen sample, as an object, which is contained in the container such as a micro plate, various measurements such as fluorescence measurement, luminescence measurement, and absorption measurement are performed according to aims.

These measurements are performed so as to capture the image by imaging the container containing the specimen sample by a camera. For this reason, a dedicated image capturing apparatus is used (for example, refer to Patent Document 1). In an example shown in Patent Document 1, a micro plate is held in a horizontal attitude below the camera that is disposed such that the imaging direction of the camera faces downward. The camera images the micro plate from the upper surface side thereof to capture the image.

Patent Document 1: U.S. Pat. No. 6,377,346

However, in measurement of the specimen sample as the object in the container such as the micro plate, there is a need for changing the imaging direction according to a portion of a measurement object. For example, when the measurement of the specimen sample as the object in wells of the micro plate is performed, the image is typically captured from an aperture side of the wells. However, when cells in a culture medium that is attached on the bottom surface of the wells are the objects to be measured, there is a need for imaging the micro plate from the lower surface side. However, in a prior art shown in the example of Patent Document 1 described above, when the imaging direction is changed as described above, it is necessary to perform the measurement in a state where the entire apparatus is inversed. In addition, it is difficult to correspond to various measurement contents with good operability by using the same apparatus.

### SUMMARY OF THE INVENTION

The present invention has been finalized in view of the above problem, and it is an object of the invention to provide an image capturing apparatus that is able to correspond to various measurement contents with good operability.

An image capturing apparatus of the present invention for capturing an image of an observation object by imaging a plate-like container in which the observation object is contained, includes: a housing unit in which an imaging unit having a horizontal first optical axis as an imaging optical axis, and an illumination unit having a second optical axis as an illumination optical axis which is set below the first optical axis to be parallel to the first optical axis are housed in a positional relation that the imaging unit and the illumination unit vertically overlap each other; a container holding unit which holds the plate-like container in a horizontal attitude at a selected observation position of a first observation position which is set at a side of an object to be imaged by the imaging unit so as to be at a middle-height position between the first optical axis and the second optical axis and a second observation position which is set at a position higher than the first optical axis above the first observation position; an optical path switching unit which is disposed at a middle position interposed between the first observation position and the second observation position and bends an optical path of light irradiated along the first optical axis to either side of the first observation position or the second observation position; an optical member which is disposed between the imaging unit and the middle position, transmits light in a predetermined wavelength region of the light which is in an incident direction to the imaging unit along the first optical axis to enter the transmitted light in the imaging unit, and reflects downward the light in the other wavelength regions; an optical member moving mechanism which moves the optical member so that the first optical axis and the optical member intersect each other or separate from the intersecting state; and an illumination light reflecting mirror which is disposed below the optical member intersecting the first optical axis, reflects illumination light which is irradiated from the illumination unit along the second optical axis toward the optical member, and further enters the reflected light of the illumination light which is incident on the optical member to the optical path switching unit.

According to the image capturing apparatus of the invention, the imaging unit having the first optical axis and the illumination unit having the second optical axis are housed in the positional relation that the imaging unit and the illumination unit vertically overlap each other. In addition, the plate-like container is held in a horizontal attitude at a selected observation position of the first observation position and the second observation position which are set at positions higher and lower than the first optical axis, respectively, at the side of the object to be imaged by the imaging unit. In addition, using the optical path switching unit that is disposed at the middle position interposed between the first observation position and the second observation position, the optical path of the light irradiated along the first optical axis is bent to any one side of the first observation position and the second observation position. Accordingly, it is possible to correspond to various measurement contents with good operability by using the same apparatus because the observation is allowed to be performed from any one of the upper side and the lower side of the container holding unit.

### BRIEF DESCRIPTION OF THE DRAWINGS

FIG. 1 is a side view illustrating the entire configuration of an image capturing apparatus according to an embodiment of the present invention;

FIG. 2 is a partially sectional view of the image capturing apparatus according to the embodiment of the present invention;

FIG. 3 is a partially sectional view of the image capturing apparatus according to the embodiment of the present invention;

FIG. 4 is a partially sectional view of the image capturing apparatus according to the embodiment of the present invention;

FIG. 5 is a partially sectional view of the image capturing apparatus according to the embodiment of the present invention;

FIG. 6 is a view illustrating an operation of a container transporting unit of the image capturing apparatus according to the embodiment of the present invention;

FIG. 7 is a view illustrating measurement processing of the image capturing apparatus according to the embodiment of the present invention;

FIG. 8 is a view illustrating measurement processing of the image capturing apparatus according to the embodiment of the present invention;

FIG. 9 is a view illustrating measurement processing of the image capturing apparatus according to the embodiment of the present invention;

FIG. 10 is a view illustrating measurement processing of the image capturing apparatus according to the embodiment of the present invention;

FIG. 11 is a view illustrating measurement processing of the image capturing apparatus according to the embodiment of the present invention; and

FIG. 12 is a view illustrating measurement processing of the image capturing apparatus according to the embodiment of the present invention.

### DESCRIPTION OF THE PREFERRED EMBODIMENTS

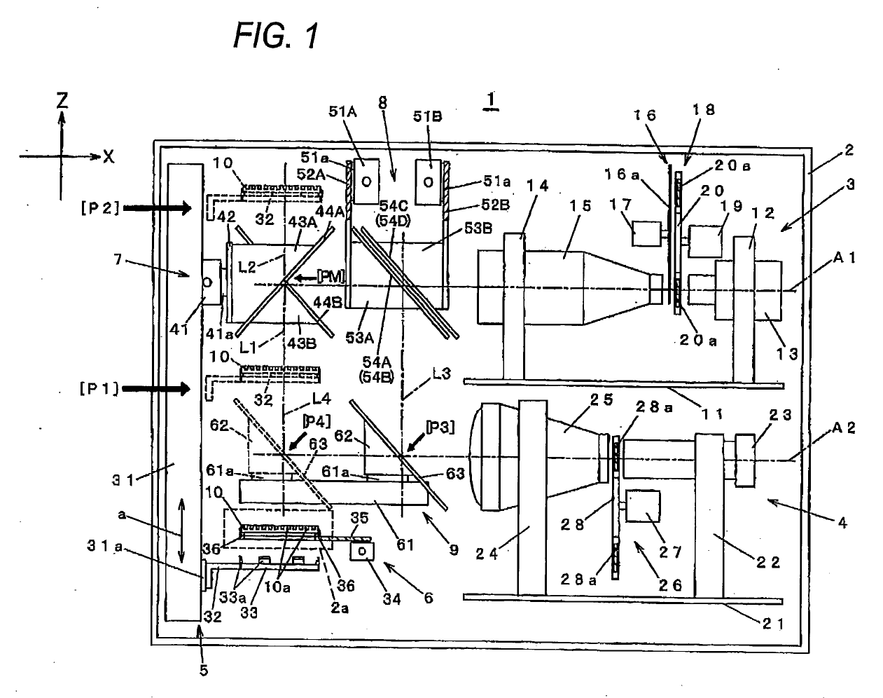

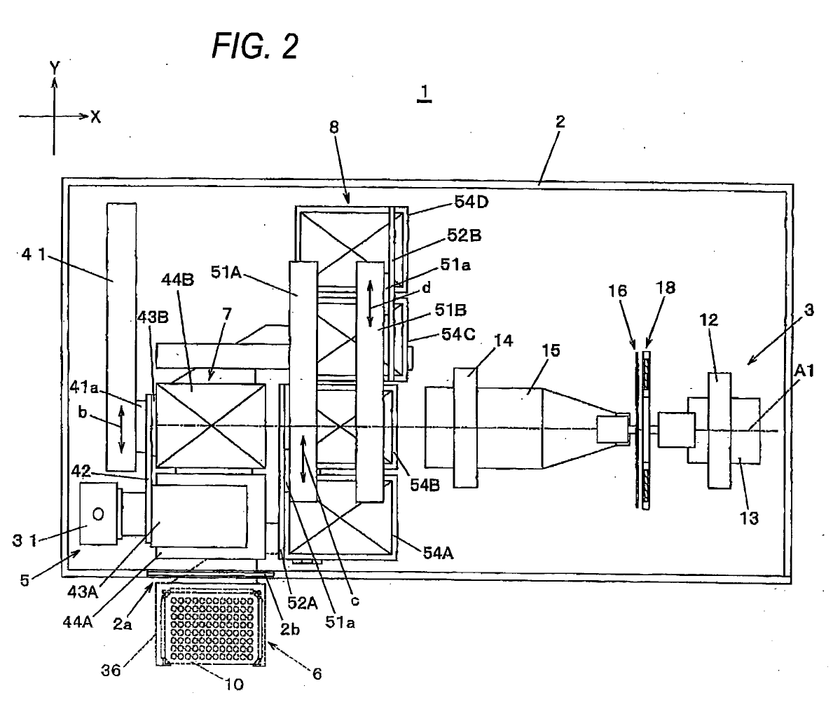

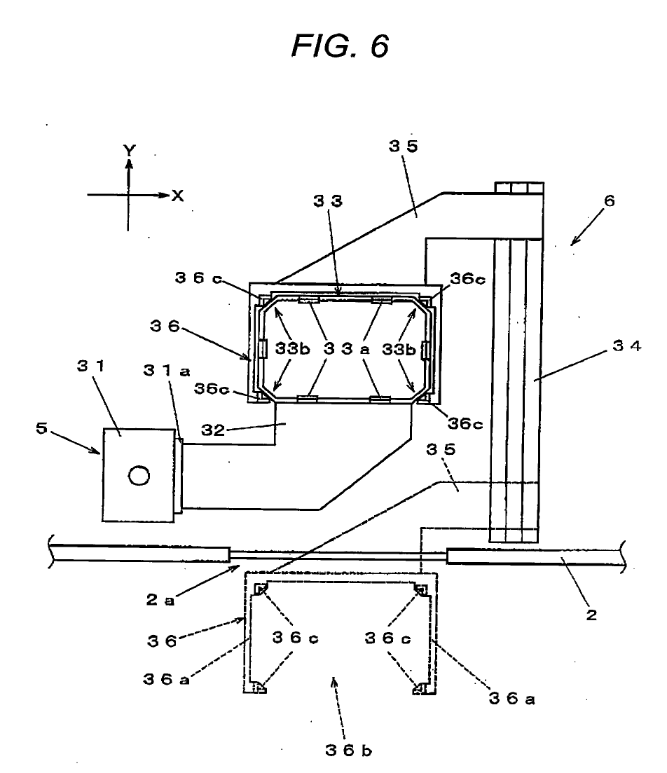

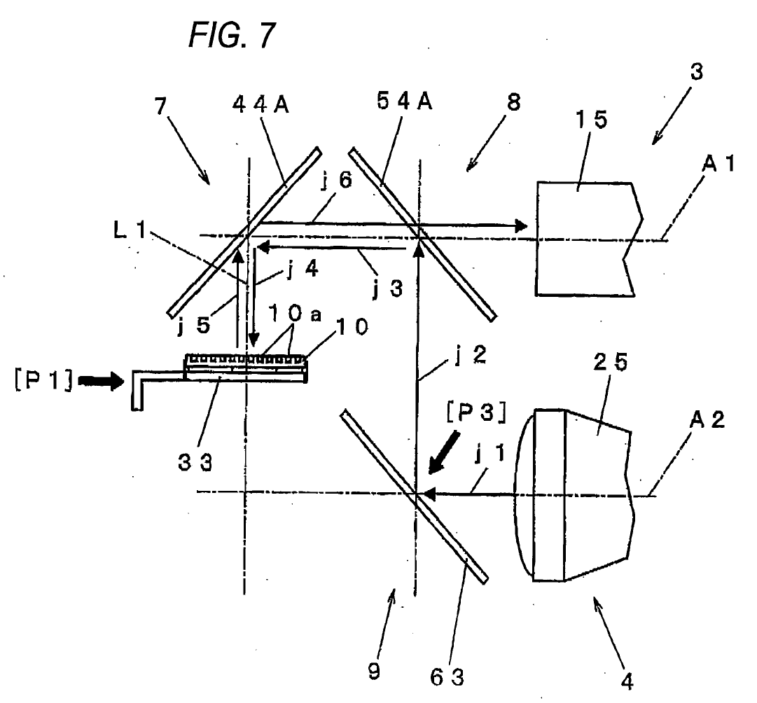

Next, embodiments of the present invention will be described with reference to the accompanying drawings. FIG. 1 is a side view illustrating the entire configuration of the image capturing apparatus according to an embodiment of the present invention. FIGS. 2 to 5 are partially sectional views of the image capturing apparatus according to the embodiment of the present invention. FIG. 6 is a view illustrating an operation of a container transporting unit of the image capturing apparatus according to the embodiment of the present invention. FIGS. 7 to 12 are views illustrating measurement processing of the image capturing apparatus according to the embodiment of the present invention.

First, the entire configuration of the image capturing apparatus 1 will be described with reference to FIG. 1. The image capturing apparatus 1 has a function that captures an image of an observation object by imaging a plate-like container containing the observation object. In the embodiment, liquid samples as the observation object are contained in plural wells of a micro plate that is a plate-like container. These liquid samples are imaged so as to capture the image thereof by using a camera. Therefore, various kinds of measurement processing such as fluorescence measurement, luminescence measurement, and absorption measurement are performed on the liquid sample as the object on the basis of captured image information.

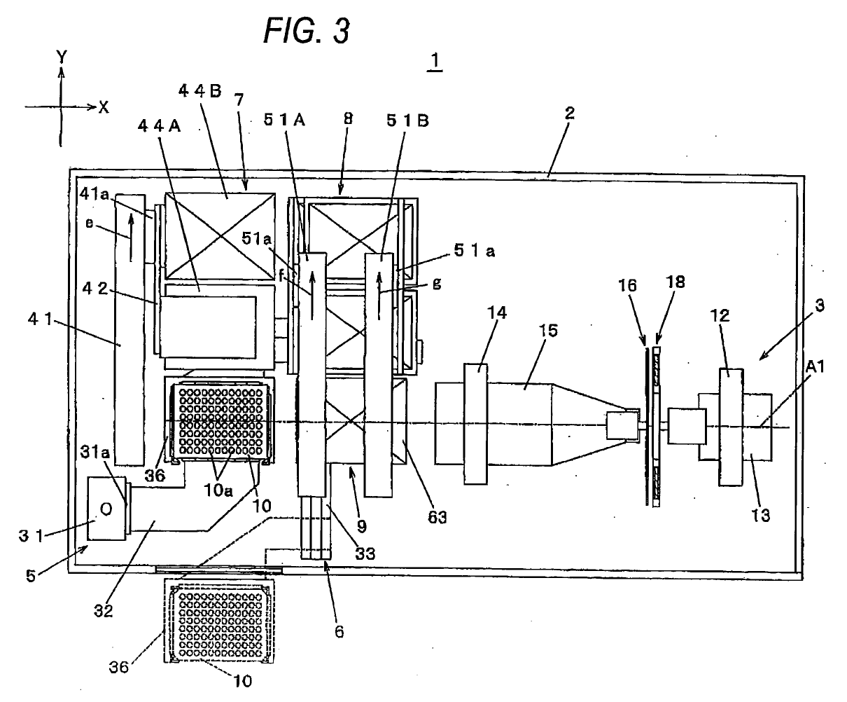

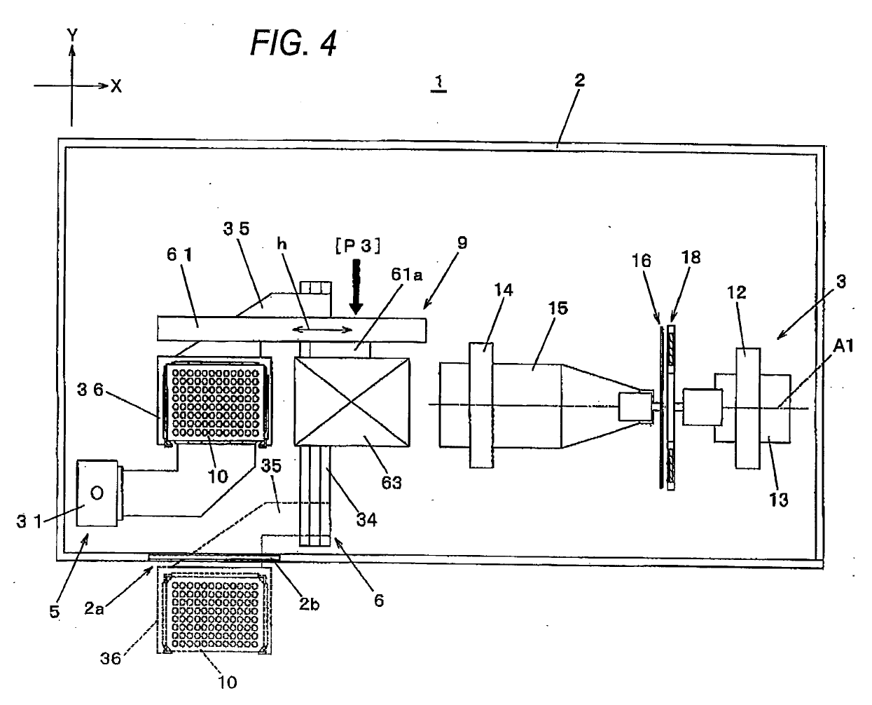

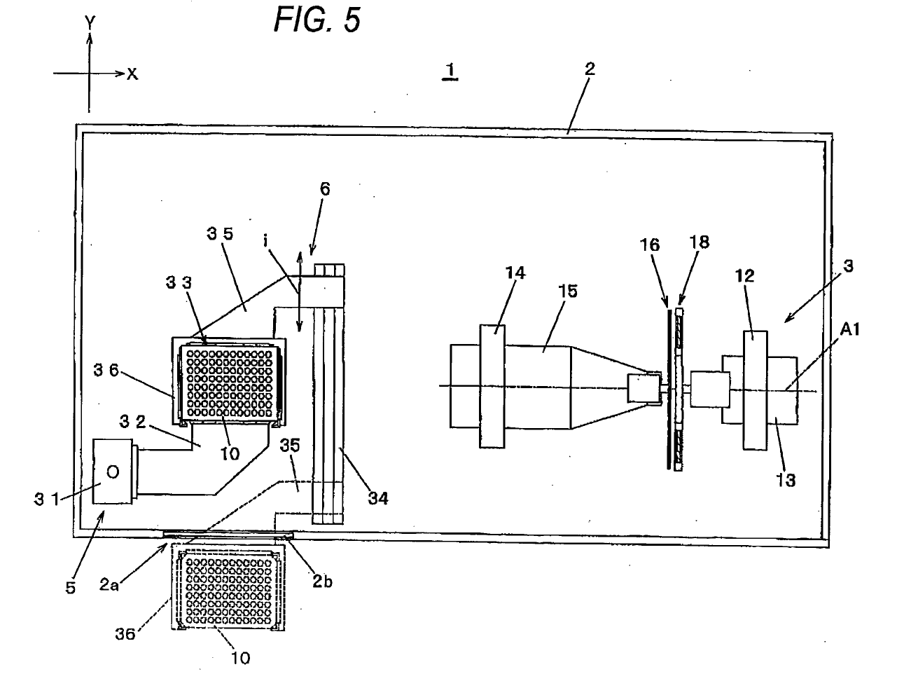

In FIG. 1, the image capturing apparatus 1 is configured such that an imaging unit 3, an illumination unit 4, a container elevating unit 5, a container transporting unit 6, an optical path switching unit 7, a diachronic mirror unit 8, and an illumination light reflecting unit 9 are disposed in a housing unit 2. Hereinafter, configurations and functions of respective units will be described with reference to FIGS. 2 to 6. In addition, FIG. 2 and FIG. 3 show a horizontal section of the inside of the housing unit 2 viewed from the upper surface side, and FIG. 4 shows the horizontal section in which the optical switching unit 7 and the dichroic mirror unit 8 are removed from the horizontal section. In addition, FIG. 5 shows the horizontal section in which the illumination light reflecting unit 9 is removed from FIG. 4, and FIG. 6 is an enlarged view illustrating details of configuration and operation of the container elevating unit 5 and the container transporting unit 6.

The configuration of the imaging unit 3 will be described. A base plate 11 is horizontally disposed on a right half portion in the inside of the housing unit 2. In addition, a camera 13 and an imaging optical system 15 are held on brackets 12 and 14, respectively, each of which is erectly provided on the base plate 11, in a horizontal attitude in order to match optical axes of the camera 13 and the imaging optical system 15 with a first optical axis A1 which is horizontally set. The camera 13 includes an image element such as a CCD, and receives imaging light from the object to be imaged, which is positioned on a left half portion in the housing unit 2, through the imaging optical system 15 to output a video signal.

The imaging unit 3 includes an optical chopper 16 and a rotating filter 18. The optical chopper 16 is configured such that a rotating disc 16a, in which transmission openings (not shown) are provided, is driven to rotate by a motor 17. The imaging light which is incident through the imaging optical system 15 is received to the camera 13 only in the state where the transmission opening is matched with the first optical axis A1 by rotating the rotating disc 16a, and the imaging light in the other states is blocked by the rotating disc 16a. By controlling rotation of the motor 17, the camera 13 can be exposed at predetermined timing by a predetermined period of time.

The rotating filter 18 is configured such that a rotating disk 20 on which plural filters 20a are attached is driven to rotate by a motor 19. In addition, the imaging light that is incident through the imaging optical system 15 by matching the filter 20a with the first optical axis A1 is received to the camera 13 in a state of being filtered according to filter characteristics of the attached filters 20a. That is, it is possible that only a specific light of the imaging light from the object to be imaged is incident on the camera 13, or the imaging light in which the specific light is removed is incident on the camera 13. In the embodiment, since the fluorescence measurement is included in the measurement method as the object, a filter having characteristics of transmitting fluorescence and blocking excitation light from a light source is included in the plural filters 20a which are attached on the rotating disc 20.

Next, a structure of the illumination unit 4 that is disposed below the imaging unit 3 will be described. In the housing unit 2, a base plate 21 is horizontally disposed below the base plate 11, and brackets 22 and 24 are erectly provided on the base plate 21. The bracket 22 and the bracket 24 are held in a horizontal attitude in order to match optical axes of an LED light source unit 23 and an illumination optical system 25 with a second optical axis A2 which is horizontally set. The LED light source unit 23 has an LED (light emitting diode) as a light source built therein, and the illumination light emitted from the LED light source unit 23 is irradiated in a direction along the second optical axis A2 with respect to the object to be imaged through the illumination optical system 25.

The illumination unit 4 includes a rotating filter 26 for filtering the illumination light from the LED light source unit 23. The rotating filter 26 is configured such that a rotating disc 28 on which filters 28a are attached is driven to rotate by a motor 27. In addition, by matching the filter 28a with the second optical axis A2, the illumination light which is emitted by the LED light source unit 23 is irradiated through the illumination optical system 25 in a state of being filtered according to the filter characteristics of the attached filers 28a. In the embodiment, since the fluorescence measurement is included in the measurement method as the object, an excitation filter is included in the plural filters 28a which are attached on the rotating disc 28, which has a function of extracting light having a wavelength required for exciting a fluorescent material as the object from the illumination light which is emitted from the LED light source unit 23. By using the imaging unit 3 and the illumination unit 4 having the configuration and the function described above, it is possible to perform a time-resolved fluorescence technique of measuring a temporal transition of intensity in fluorescence, which is emitted from the object to be measured, by the imaging capturing apparatus 1.

In above-mentioned configuration, the imaging capturing apparatus 1 is configured such that the imaging unit 3 having the horizontal first optical axis A1 as an imaging optical axis and the illumination unit 4 having the second optical axis A2 as an illumination optical axis which is horizontally set below the first optical axis A1 to be parallel to the first optical axis A1 are included in the housing unit 2. In addition, the housing unit 2 houses the imaging unit 3 and the illumination unit 4 in a positional relation therebetween to be vertically disposed so as to be overlapped with each other. Even if it is necessary to change the observation direction according to the portions of the measurement object, by disposing the imaging unit 3 and the illumination unit 4 in the positional relation described above, it is possible to correspond to various measurement contents with the good operability by using the same apparatus, which will be describe later.

Next, the container elevating unit 5 for holding and elevating the micro plate 10 which is a plate-like container in which a liquid sample (observation object) is contained will be described. In addition, an example of the micro plate 10 in which wells are provided is shown as the plate-like container. However, as the plate-like container, a glass plate may be used in which the liquid sample is simply contained. An elevating table 31 is disposed to be erected at the left end portion in the housing unit 2. Further, a substantial plate-like container holding unit 33 (refer to FIG. 6) is connected with an elevating member 31a of the elevating table 31 via a connecting bracket 32. A position holding member 33a for placing the micro plate 10 on a fixed position is provided on the container holding unit 33. In addition, four corner portions of the container holding unit 33 are cut so as to form corner cut portions 33b. By driving the elevation table 31 in a state where the micro plate 10 is placed on the container holding unit 33, the micro plate 10 is elevated together with the container holding unit 33 (arrow a).

A first observation position [P1] and a second observation position [P2] for imaging and observing the micro plate 10 by the imaging unit 3 are set in a stroke range in which the container holding unit 33 is elevated by the elevating table 31. The first observation position [P1] is set at a side of the object to be imaged by the imaging unit 3, that is, at a middle-height position between the first optical axis A1 and the second optical axis A2 in the left half portion in the housing unit 2. Further, the second observation position [P2] is set at a position higher than the first optical axis A1 above the first observation position [P1]. By driving the elevating table 31, it is possible to position the container holding unit 33 on which the micro plate 10 is placed at any of the first observation position [P1] and the second observation position [P2]. Accordingly, the micro plate 10 which is held by the container holding unit 33 is held at any one of the first observation position [P1] and the second observation position [P2].

That is, in the above-mentioned configuration, the container holding unit 33 is elevated by the elevating table 31, and holds the micro plate 10 which is the plate-like container in a horizontal attitude at a selected observation position of the first observation position [P1] and the second observation position [P2]. The elevating table 31 is an elevating mechanism for elevating the container holding unit 33. The elevating mechanism moves the container holding unit 33 to the first observation position [P1] or the second observation position [P2].

Next, the optical path switching unit 7 will be described. On an extended line of the first optical axis A1, the optical path switching unit 7 is disposed at a middle position [PM] between the first observation position [P1] and the second observation position [P2]. The optical path switching unit 7 is configured such that two mirrors of a first mirror 44A and a second mirror 44B are provided to freely move in a Y direction by a moving table 41 (refer to FIG. 2) which is disposed horizontally in the Y direction at a position of the same height as that of the first optical axis A1.

Mirror holding members 43A and 43B are connected to a moving member 41a of the moving table 41 via a connecting bracket 42. Further, the mirror holding member 43A and 43B hold a first mirror 44A and a second mirror 44B that are held in an inclined attitude of 45° down and 45° up, respectively. The first mirror 44A and the second mirror 44B are moved in the Y direction (refer to arrow b shown in FIG. 2) by driving the moving table 41, and thus it is possible to move any one of them to a position intersecting the first optical axis A1. The moving table 41 is a mirror moving mechanism that horizontally moves the first mirror 44A and the second mirror 44B.

That is, the second mirror 44B is moved to the position intersecting the first optical axis A1 by driving the moving table 41 to move the moving member 41a to the position of arrow b shown in FIG. 2. In addition, the first mirror 44A is moved to the position intersecting the first optical axis A1 by further moving the moving member 41a in the Y direction (upper side in FIG. 2). Furthermore, both the first mirror 44A and the second mirror 44B can be separated from the position intersecting the first optical axis A1 by moving the moving member 41a to a position of arrow e shown in FIG. 3. Therefore, a space above the container holding unit 33 becomes clear, and thus it is possible to elevate the container holding unit 33, on which the micro plate 10 is held, in the container elevating unit 5.

In a state that the first mirror 44A is at the position intersecting the first optical axis A1, light which is incident on the first mirror 44A along the first optical axis A1 proceeds along an optical path L1 which is extended from the first optical axis A1 bent to the lower side in a vertical direction to the side of the first observation position [P1]. In addition, opposite to the direction of the light, the light which is incident on the first mirror 44A from the lower side in the vertical direction along the optical path L1 proceeds in a direction to the imaging unit 3 along the first optical axis A1. Similarly, in a state that the second mirror 44B is at the position intersecting the first optical axis A1, the light which is incident on the second mirror 44B along the first optical axis A1 proceeds along an optical path L2 which is extended from the first optical axis A1 bent to the upper side in the vertical direction to the side of the second observation position [P2]. In addition, opposite to the direction of the light, the light which is incident on the second mirror 44B from the upper side in the vertical direction along the optical path L2 proceeds in a direction to the imaging unit 3 along the first optical axis A1.

That is, in the above-mentioned configuration, the optical path switching unit 7 is disposed in the middle position [PM] interposed between the first observation position [P1] and the second observation position [P2], and has a function to bend the optical path of the light irradiated along the first optical axis A1 to any side of the first observation position [P1] (optical path L1) or the second observation position [P2] (optical path L2). The optical path switching unit 7 is configured to include: the first mirror 44A and the second mirror 44B which bend the direction of the optical path along the first optical axis A1 to the sides of the first observation position [P1] and the second observation position [P2], respectively; and the mirror moving mechanism which horizontally moves the first mirror 44A and the second mirror 44B.

By adopting the configuration described above, in measurement of the liquid sample as the object in the micro plate 10 which is held on the container holding unit 33, it is possible to easily switch the direction to observe the micro plate 10, that is, an upper surface observation for observing the micro plate 10 from the upper surface side thereof and a lower surface observation for observing the micro plate 10 from the lower surface side thereof. In addition, in switching of the observation direction, since the optical path switching unit 7 is positioned at the middle position [PM] between the first observation position [P1] and the second observation position [P2], the optical path length in the case of the upper surface observation becomes equal to the optical path length in the case of the lower surface observation. For this reason, even though the observation position is changed, it becomes possible that optical treatments in irradiating of the illumination light by the illumination unit 4 and in receiving the imaging light by the imaging unit 3 are performed as the same. As a result, the configuration is preferable in manufacturing the apparatus or in rapid measuring operations.

Next, the container transporting unit 6 which carries in the micro plate 10 into the housing unit 2 or carries out the micro plate 10 from the housing unit 2 will be described. As shown in FIGS. 1 and 2, an opening 2a which is communicated with the outside is provide in the vicinity of a lower limit position for elevating the container holding unit 33 in the side surface of the housing unit 2, and a shutter 2b is provided to be freely opened or closed at the opening 2a. As shown in FIG. 5, a moving table 34 is disposed in the housing unit 2 in the Y direction, and a connecting bracket 35 that is horizontally extended in the X direction is connected to a moving member (not shown) of the moving table 34. The connecting bracket 35 is moved in the Y direction (refer to arrow i) by driving the moving table 34.

A plate delivery unit 36 that holds the micro plate 10 is provided on the tip portion of the connecting bracket 35. The plate delivery unit 36 protrudes to the outside of the housing unit 2 through the opening 2a by driving the moving table 34 to move the connecting bracket 35 to the side of the opening 2a. As shown in FIG. 6, the plate delivery unit 36 includes two fork-like holding arms 36a which protrudes outside. A delivery space 36b is formed between two holding arms 36a so as to have a size of the opening through which the container holding unit 33 of the container elevating unit 5 can be inserted.

Plate holding units 36c are provided on the holding arms 36a corresponding to four corner portions of the micro plate 10. The micro plate 10 is held by the plate delivery unit 36 by positioning the respective corner portions of the micro plate 10 at the plate holding units 36c. Supplying or withdrawing of the micro plate 10 to the plate delivery unit 36 is performed in a state that the plate delivery unit 36 protrudes to the outside of the housing unit 2 through the opening 2a.

That is, the micro plate 10 is supplied from the outside of the housing unit 2 to the plate delivery unit 36 which moves the micro plate 10 into the housing unit 2, and a plate delivery operation is performed between the container holding unit 33 of the container elevating unit 5 and the plate delivery unit 36, so that the micro plate 10 is delivered to the container holding unit 33. After completing measurement processing, the micro plate 10 is delivered from the container holding unit 33 to the plate delivery unit 36, and then is carried out to the outside of the housing unit 2 through the opening 2a. The moving table 34, the connecting bracket 35, and the plate delivery unit 36 configure a container transporting unit 6 which carries in the micro plate 10 to a path for moving the container holding unit 33 by the elevating table 31.

The plate delivery operation described above is performed as follows. First, in delivering the micro plate 10 from the plate delivery unit 36 to the container holding unit 33, the container holding unit 33 is ascended through the delivery space 36b in a state that the container holding unit 33 is positioned at the lower side of the plate delivery unit 36. Therefore, the position holding members 33a which are provided on the container holding unit 33 come into contact with the micro plate 10 from the lower surface, and the micro plate 10 is lifted up by the container holding unit 33, and thus the delivering the micro plate 10 held by the plate holding units 36c to the container holding unit 33 is completed. In addition, in delivering the micro plate 10 from the container holding unit 33 to the plate delivery unit 36, the above-mentioned plate delivery operation is performed in reverse.

In the plate delivery operation, since the corner cut portions 33b are provided on the respective corner portions of the container holding unit 33, it is possible to perform the delivery of the micro plate 10 without interference between the plate holding unit 36c and the container holding unit 33. That is, in the above-mentioned configuration, the opening 2a as a container entrance is formed on the side surface of the housing unit 2. In addition, the container transporting unit 6 which carries in the micro plate 10 from the opening 2a to transport the micro plate 10 to the path for moving the container holding unit 33 by the elevating table 31 is included.

Next, the dichroic mirror unit (optical member unit) 8 will be described. In FIG. 1, the dichroic mirror unit 8 is disposed between the imaging unit 3 and the middle position [PM] on which the optical path switching unit 7 is positioned. As shown in FIGS. 1 and 2, the dichroic mirror unit 8 includes two tables of a first moving table 51A and a second moving table 51B which are disposed in the Y direction. Further, a connecting bracket 52A and a connecting bracket 52B which are extended downward are mounted on the first moving table 51A and the second moving table 51B via moving members 51a, respectively.

Two dichroic mirrors 54A and 54B are connected to the connecting bracket 52A via a mirror holding member 53A. In addition, two dichroic mirror 54C and 54D are connected to the connecting bracket 52B via a mirror holding member 53B. The dichroic mirrors 54A, 54B, 54C, and 54D are optical members with characteristics that light in a specific wavelength region is transmitted and light in the other wavelength regions is reflected. In the embodiment, since different kinds of measurement such as the fluorescence measurement and the absorption measurement are performed by the same apparatus, the dichroic mirror unit 8 includes plural dichroic mirrors, each of which has a different wavelength characteristic. In addition, in the embodiment, the dichroic mirrors are used as the optical member to transmit the light in the specific wavelength region and reflect the light in the other wavelength regions. However, other things such as a dichroic prism having the same function as that of the dichroic mirror may be used as the optical member described above.

As shown in FIG. 2, the dichroic mirrors 54A and 54B are moved in the Y direction by driving the first moving table 51A (refer to arrow c), and thus it is possible to move any one of them to the position intersecting the first optical axis A1. In addition, the dichroic mirrors 54C and 54D are moved in the Y direction by driving the second moving table 51B (refer to arrow d), and thus it is possible to move any one of them to the position intersecting the first optical axis A1. Furthermore, as shown in FIG. 3, by driving the first moving table 51A and the second moving table 51B to move the moving member 51a to the position shown by arrows f and g, all the dichroic mirrors 54A, 54B, 54C, and 54D are separated from the position intersecting the first optical axis A1. Therefore, when the function of the dichroic mirrors is not requested according to the kinds and forms of measurement it is possible to separate all the dichroic mirrors 54A, 54B, 54C, and 54D from the position intersecting the first optical axis A1.

That is, in the above-mentioned configuration, the dichroic mirrors 54A, 54B, 54C, and 54D are disposed between the imaging unit 3 and the middle position [PM] on which the optical path switching unit 7 is positioned, and have the function that the light in the predetermined wavelength region of the light which is in an incident direction to the imaging unit 3 along the first optical axis A1 is transmitted to be incident on the imaging unit 3 and the light in the other wavelength regions is reflected downward. In addition, the first moving table 51A and the second moving table 51B have the function as an optical member moving mechanism that moves these dichroic mirrors in order to intersect the first optical axis A1 and the dichroic mirrors 54A, 54B, 54C, and 54D or to be separated from the intersecting state. In the embodiment, the plural dichroic mirrors having different characteristics are included, and these plural dichroic mirrors are selectively positioned at the position intersecting the first optical axis A1 by the optical member moving mechanism.

Next, the illumination light reflecting unit 9 which is provided below the optical path switching unit 7 and the dichroic mirror unit 8 will be described. In FIG. 1, below the optical path switching unit 7 and the dichroic mirror unit 8, a mirror moving mechanism 61 is horizontally disposed below the second optical axis A2 in the X direction. An illumination light reflecting mirror 63 is connected to the moving member 61a, which is mounted on the mirror moving mechanism 61, with an inclination angle of 45° through a mirror holding member 62. A position of the height of the middle point of the illumination light reflecting mirror 63 is matched with the second optical axis A2, and the illumination light which is irradiated from the illumination unit 4 along the second optical axis A2 is incident on the illumination light reflecting mirror 63 in a horizontal direction.

The illumination light reflecting mirror 63 is moved in the X direction by driving the mirror moving mechanism 61. Therefore, the mirror moving mechanism 61 becomes an illumination light reflecting mirror moving mechanism. For this reason, it is possible to selectively position the illumination light reflecting mirror 63 at a first reflection position [P3] on which the illumination light reflecting mirror 63 is positioned immediately below the dichroic mirror unit 8, or at a second reflection position [P4] on which the illumination light reflecting mirror 63 is positioned immediately below the optical path switching unit 7. When the illumination light reflecting mirror 63 is positioned at the first reflection position [P3], the illumination light which is incident along the second optical axis A2 by the illuminating unit 4 is reflected to the upper side in a vertical direction along an optical path L3 by the illumination light reflecting mirror 63 and is incident on the dichroic mirror 54A of the dichroic mirror unit 8. Then, the reflected light of the light that is incident on the dichroic mirror 54A is incident on any one of the first mirror 44A and the second mirror 44B of the optical path switching unit 7 along the first optical axis A1.

That is, the illumination light reflecting mirror 63 of the illumination light reflecting unit 9 is disposed below the dichroic mirror intersecting the first optical axis A1 in the dichroic mirror unit 8, and has the function that the illumination light which is irradiated from the illumination unit 4 along the second optical axis A2 is reflected toward the dichroic mirror and the reflected light of the illumination light which is further incident on the dichroic mirror is incident on the optical path switching unit 7. The illumination light reflecting unit 9 is configured to include the illumination light reflecting mirror moving mechanism which selectively positions the illumination light reflecting mirror 63 at a position below the dichroic mirror unit 8 or at a position below the first observation position [P1] by moving the illumination light reflecting mirror 63 along the second optical axis A2.

The image capturing apparatus 1 is configured in the same manner as described above. Hereinafter, an actual example of various measurements processing, which is performed on the micro plate 10 as the object by using the image capturing apparatus 1, will be described. First, the most basic fluorescence measurement, that is, the case where the fluorescence measurement is performed on the aperture side of the wells 10a of the micro plate 10 as a surface of the measurement object will be described with reference to FIG. 7. In this case, the micro plate 10 that contains the liquid sample in the wells 10a is held on the container holding unit 33 to position at the first observation position [P1].

In the illumination light reflecting unit 9, the illumination light reflecting mirror 63 is positioned at the first reflection position [P3]. Further, in the dichroic mirror unit 8, the dichroic mirror 54A, which has a fluorescence measuring characteristic, that is, a characteristic for reflecting the excitation light by transmitting fluorescence, is moved to the position intersecting the first optical axis A1. Further, in the optical path switching unit 7, the first mirror 44A which is disposed in a direction (optical path L1) of the first optical axis A1 bent downward is positioned at the position intersecting the first optical axis A1.

In this state, the illumination light in the specific wavelength region, that is, the excitation light for exciting the fluorescent material as the object is incident on the illumination light reflecting mirror 63 along the second optical axis A2 through the illumination light optical system 25 by operating the illumination unit 4 (arrow j1). Therefore, the excitation light is reflected to the upper side in a vertical direction (arrow j2), and incident on the dichroic mirror 54A of the dichroic mirror unit 8 from the lower side. Next, the incident light is reflected in the horizontal direction by the dichroic mirror 54A and proceeds along the first optical axis A1 to be incident on the first mirror 44A (arrow j3). Further, the incident light is reflected to the lower side along the optical path L1 by the first mirror 44A (arrow j4) to be incident on the liquid sample in the wells 10a from the upper side.

The excitation light generates unique fluorescence because the fluorescent material in the liquid sample is excited. The imaging light including the fluorescence is incident on the first mirror 44A along the optical path L1 (arrow j5), and then the imaging light which is reflected in the horizontal direction by the first mirror 44A proceeds along the first optical axis A1 to be incident on the dichroic mirror 54A. Since the dichroic mirror 54A has the characteristic of reflecting the excitation light by transmitting the fluorescence, only the fluorescence generated from the micro plate 10 is transmitted through the dichroic mirror 54A (arrow j6). The transmitted light is imaged by the imaging unit 3. That is, the transmitted light is incident on the camera 13 through the imaging optical system 15 (refer to FIG. 1), so that the image information is obtained. Therefore, fluorescence intensity of the fluorescent material in the liquid sample is measured on the basis of the image information.

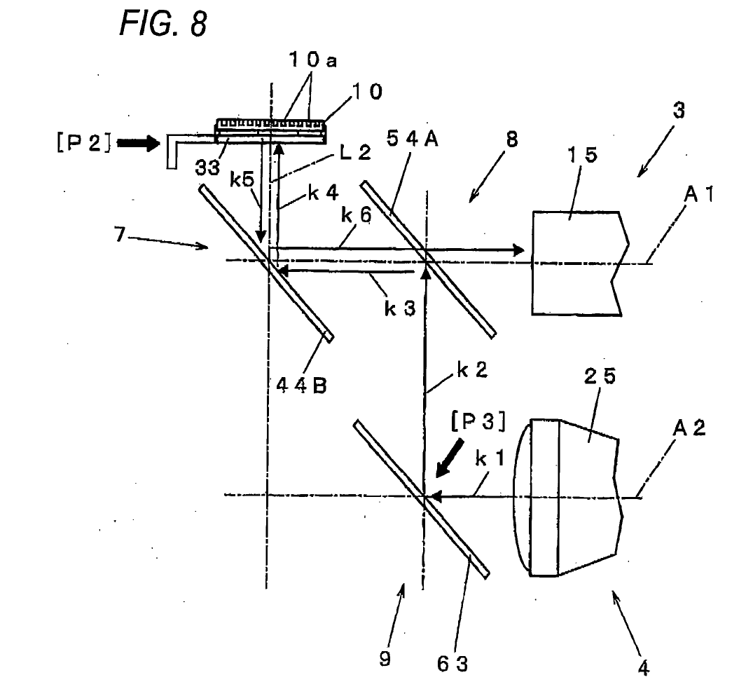

Next, an example of the fluorescence measurement which is performed in the case where the object to be measured exists on the bottom surface of the wells 10a will be described with reference to FIG. 8. In this case, the micro plate 10 in which the liquid sample is contained is positioned at the second observation position [P2]. In addition, in the illumination light reflecting unit 9, the illumination light reflecting mirror 63 is positioned at the first reflection position [P3]. Further, in the dichroic mirror unit 8, the dichroic mirror 54A for the fluorescence measurement is moved to the position intersecting the first optical axis A1. Further, in the optical path switching unit 7, the second mirror 44B which is disposed in a direction (optical path L2) of the first optical axis A1 bent upward intersects the first optical axis A1.

In this state, the excitation light is incident on the illumination light reflecting mirror 63 along the second optical axis A2 through the illumination optical system 25 by operating the illumination unit 4 (arrow k1). Therefore, the excitation light is reflected to the upper side in a vertical direction (arrow k2), and is incident on the dichroic mirror 54A of the dichroic mirror unit 8 from the lower side. Further, the incident light is reflected in the horizontal direction by the dichroic mirror 54A along the first optical axis A1 (arrow k3). Then, the incident light is further reflected to the upper side along the optical path L2 by the second mirror 44B (arrow k4) to be incident on the liquid sample in the wells 10a.

When the excitation light is incident on the object to be measured such as cells existing on the bottom surface of the wells 10a, the object to be measured generates the unique fluorescence by being excited. The imaging light including the fluorescence is incident on the second mirror 44B along the optical path L2 (arrow k5), and then the imaging light which is reflected in the horizontal direction by the second mirror 44B proceeds along the first optical axis A1 to be incident on the dichroic mirror 54A. Since the dichroic mirror 54A has the characteristic of reflecting the excitation light by transmitting the fluorescence, only the fluorescence generated from the micro plate 10 is transmitted through the dichroic mirror 54A (arrow k6). Similar to the example shown in FIG. 7, the transmitted light is imaged by the imaging unit 3.

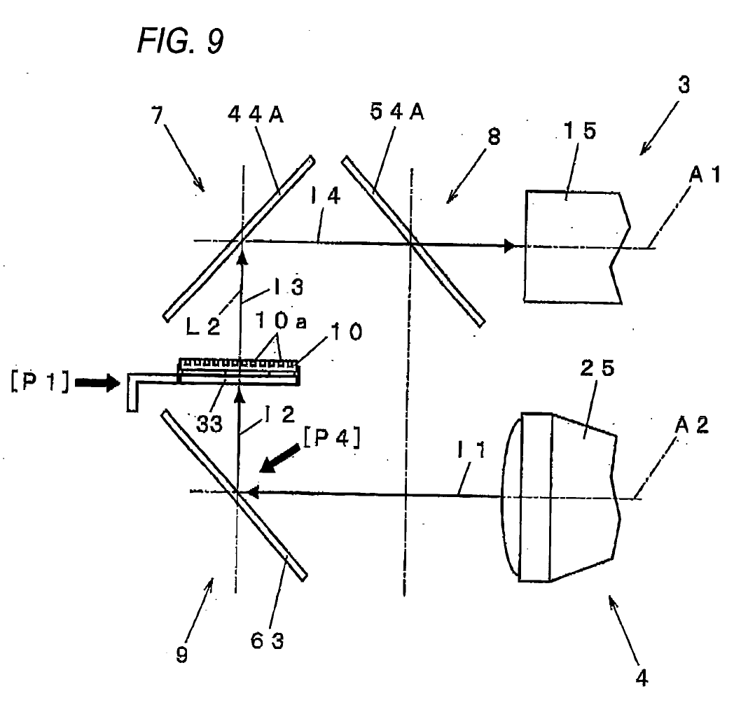

Next, an example of the fluorescence measurement in which the fluorescence is generated from the object to be measured in a state where the illumination light is absorbed into the liquid sample contained in the wells 10a will be described with reference to FIG. 9. In this case, the micro plate 10 in which the liquid sample is contained is positioned at the first observation position [P1], and in the illumination light reflecting unit 9, the illumination light reflecting mirror 63 is positioned at the second reflection position [P4] below the micro plate 10. In addition, in the optical path switching unit 7, the first mirror 44A which is disposed on the first optical axis A1 bent downward intersects the first optical axis A1. Further, in the dichroic mirror unit 8, the dichroic mirror 54A for the fluorescence measurement is moved to the position intersecting the first optical axis A1.

In this state, the excitation light is incident on the illumination light reflecting mirror 63 along the second optical axis A2 through the illumination optical system 25 by operating the illumination unit 4 (arrow 11). Therefore, the excitation light is reflected to the upper side in a vertical direction (arrow 12), and is incident on the liquid sample in the wells 10a of the micro plate 10 from the lower side. When the excitation light is absorbed into the liquid sample, the object to be measured generates the unique fluorescence since the fluorescent material is excited. The imaging light including the fluorescence is incident on the first mirror 44A along the optical path L2 (arrow 13), and then the imaging light which is reflected by the first mirror 44A proceeds in the horizontal direction along the first optical axis A1 to be incident on the dichroic mirror 54A. Since the dichroic mirror 54A has the characteristic of reflecting the excitation light by transmitting the fluorescence, only the fluorescence generated from the micro plate 10 is transmitted through the dichroic mirror 54A (arrow 14). Similar to the examples shown in FIGS. 7 and 8, the transmitted light is imaged by the imaging unit 3.

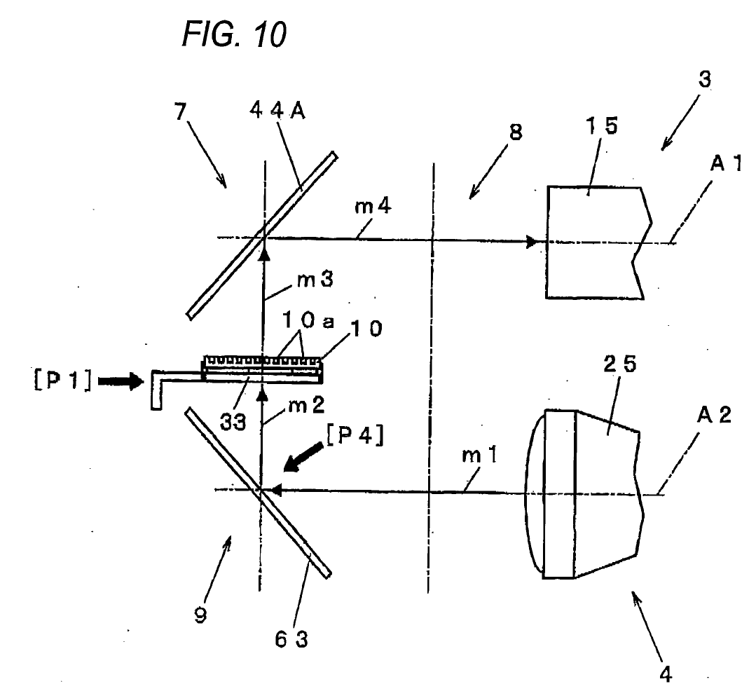

Next, an example of the measurement in which absorbance of the light to be absorbed by the liquid sample in the wells 10a is measured will be described with reference to FIG. 10. In this case, in order to irradiate measurement light to be used in measuring from the lower side of the micro plate 10, the micro plate 10 in which the liquid sample is contained is positioned at the first observation position [P1] similar to the measurement example shown in FIG. 9. Then, in the illumination light reflecting unit 9, the illumination light reflecting mirror 63 is positioned at the second reflection position [P4] below the micro plate 10. In addition, in the optical path switching unit 7, the first mirror 44A intersects the first optical axis A1. Further, since the dichroic mirrors are not used in this measurement example, all the dichroic mirrors 54A, 54B, 54C, and 54D in the dichroic mirror unit 8 are evacuated from the position intersecting the first optical axis A1.

In this absorption measurement, the measurement light for the absorption measurement is irradiated by operating the illumination unit 4 along the second optical axis A2 (arrow m1), being incident on the illumination light reflecting mirror 63 to be reflected to the upper side in a vertical direction (arrow m2), and being incident on the liquid sample contained in the wells 10a of the micro plate 10 from the lower side. In the incident light, the light that is further transmitted through the liquid sample after absorbed into the liquid sample in the wells 10a proceeds to the upper side in a vertical direction (arrow m3) to be incident on the first mirror 44A. The reflection light of the incident light proceeds in the horizontal direction along the first optical axis A1, thereby being received to the imaging unit 3. As a result, the absorbance of the liquid sample in the wells 10a is measured.

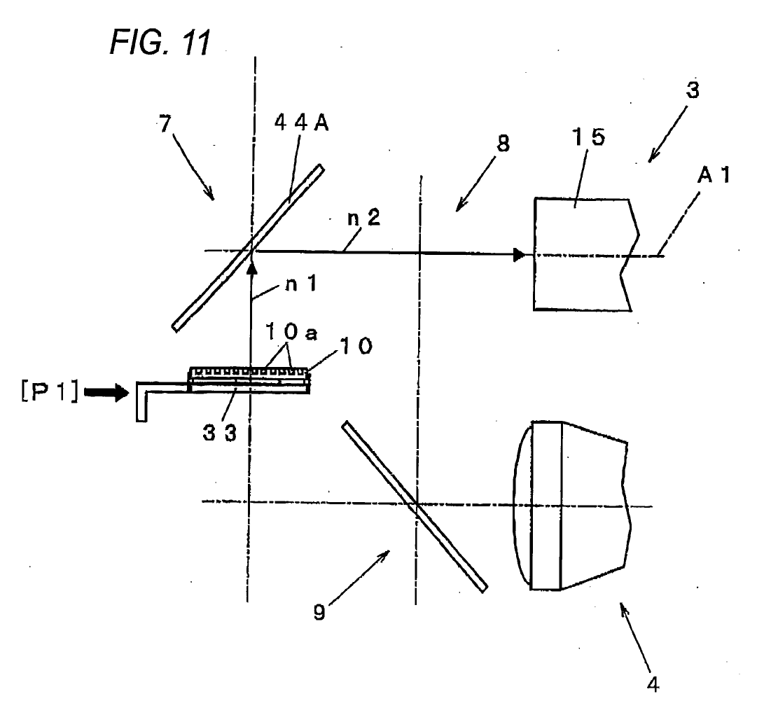

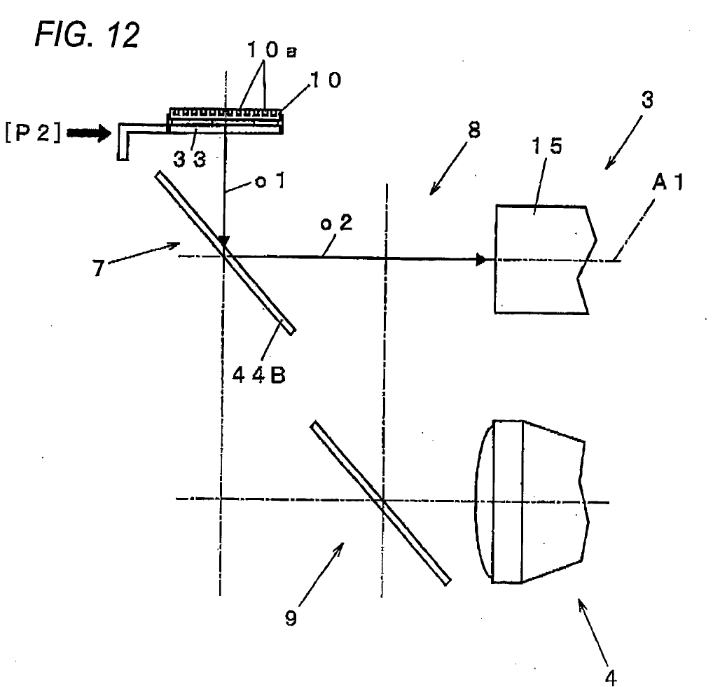

Next, an example of the luminescence measurement that is performed by receiving the light generated due to a chemical reaction of the liquid sample itself in the wells 10a will be described with reference to FIGS. 11 and 12. FIG. 11 shows an example where the light to be generated toward the upper side from the liquid sample in the wells 10a is the object to be measured. In this case, the micro plate 10 in which the liquid sample is contained is positioned at the first observation position [P1]. Further, in the optical path switching unit 7, the first mirror 44A is moved to the position intersecting the first optical axis A1.

In this state, the light generated from the liquid sample in the wells 10a proceeds to the upper side to be incident on the first mirror 44A (arrow n1), being reflected in the horizontal direction by the first mirror 44A and proceeding along the first optical axis A1 (arrow n2) to be received to the imaging unit 3. Since the illumination light is not requested for the luminescence measurement, the functions of the illumination unit 4, the dichroic mirror unit 8, and the illumination light reflecting unit 9 are not used. Further, in the dichroic mirror unit 8, all the dichroic mirrors are kept in a state of being separated.

FIG. 12 shows an example, in the same luminescence measurement, where the light emitted toward the lower side from the liquid sample in the wells 10a is the object to be measured. In this case, the micro plate 10 in which the liquid sample is contained is positioned at the second observation position [P2]. Further, in the optical path switching unit 7, the second mirror 44B is moved to the position intersecting the first optical axis A1. In this state, the light emitted from the liquid sample in the wells 10a proceeds to the lower side to be incident on the second mirror 44B (arrow o1), reflecting in the horizontal direction by the second mirror 44B and proceeding along the first optical axis A1 (arrow o2) to be received to the imaging unit 3. Similar to the example shown in FIG. 11, the functions of the illumination unit 4, the dichroic mirror unit 8, and the illumination light reflecting unit 9 are not used also in this luminescence measurement.

As described above, in the image capturing apparatus of the invention, the imaging unit 3 having the first optical axis A1 and the illumination unit 4 having the second optical axis A2 are housed in the positional relation therebetween to be vertically overlapped with each other. In addition, the micro plate 10 which is the plate-like container is held in a horizontal attitude at a selected observation position of the first observation position [P1] and the second observation position [P2] which are set at the positions higher or lower than the first optical axis A1, respectively, at the side of the object to be imaged by the imaging unit 3. In addition, by using the optical path switching unit 7 which is disposed at the middle position [PM] interposed between the first observation position [P1] and the second observation position [P2], the optical path of the light irradiated along the first optical axis A1 is bent to any side of the first observation position [P1] and the second observation position [P2].

With this configuration, in the image measurement of the micro plate 10 as the object, it is possible to capture the image of any side of the upper surface and the lower surface by easily switching the observation direction of the micro plate 10. Accordingly, there is no need for the operation to inverse the entire apparatus which has been requested for the prior art when the image capturing direction is changed, but it is possible to correspond to various measurement contents with good operability by using the same apparatus because the measurement is allowed to be performed from any one of the upper side and the lower side of the micro plate 10.

The image capturing apparatus of the present invention can advantageously correspond to various measurement contents with good operability by using the same apparatus, and is useful for the high throughput screening which estimates a large amount of specimen samples in pharmaceutical industries.

What is claimed is:

1. An image capturing apparatus capturing an image of an observation object by imaging a plate-like container in which the observation object is contained, comprising:
a housing unit in which an imaging unit having a horizontal first optical axis as an imaging optical axis, and an illumination unit having a second optical axis as an illumination optical axis which is set below the first optical axis to be parallel to the first optical axis are housed in a positional relation that the imaging unit and the illumination unit vertically overlap each other;
a container holding unit which holds the plate-like container in a horizontal attitude at a selected observation position of a first observation position which is set at a side of an object to be imaged by the imaging unit so as to be at a middle-height position between the first optical axis and the second optical axis and a second observation position which is set at a position higher than the first optical axis above the first observation position;
an optical path switching unit which is disposed at a middle position interposed between the first observation position and the second observation position and bends an optical path of light irradiated along the first optical axis to either side of the first observation position or the second observation position;
an optical member which is disposed between the imaging unit and the middle position, transmits light in a predetermined wavelength region of the light which is in an incident direction to the imaging unit along the first optical axis to enter the transmitted light in the imaging unit, and reflects downward the light in the other wavelength regions;
an optical member moving mechanism which moves the optical member so that the first optical axis and the optical member intersect each other and separate from the intersecting state; and
an illumination light reflecting mirror which is disposed below the optical member intersecting the first optical axis, reflects illumination light which is irradiated from the illumination unit along the second optical axis toward the optical member, and further enters the reflected light of the illumination light which is incident on the optical member to the optical path switching unit.

2. The image capturing apparatus according to claim 1, further comprising an elevating mechanism elevating the container holding unit,
wherein the elevating mechanism moves the container holding unit to the first observation position or the second observation position.

3. The image capturing apparatus according to claim 1, wherein the optical path switching unit includes:
a first mirror and a second mirror which bend a direction of the optical path to the first observation position and the second observation position, respectively; and
a mirror moving mechanism which horizontally moves the first mirror and the second mirror.

4. The image capturing apparatus according to claim 1, further comprising:
a plurality of optical members which are different from each other in characteristics,
wherein the optical member moving mechanism selectively positions the plurality of the optical members at a position intersecting the first optical axis.

5. The image capturing apparatus according to claim 2, wherein the housing unit includes a container entrance which is formed on a side surface, and the image capturing apparatus further comprises a container transporting unit which carries in a container from the container entrance to a path for moving the container holding unit by the elevating mechanism.

6. The image capturing apparatus according to claim 1, further comprising: an illumination light reflecting mirror moving mechanism which selectively positions the illumination light reflecting mirror at a position below the optical member or at a position below the first observation position by moving the illumination light reflecting mirror along the second optical axis.
